(19) United States
(12) Patent Application Publication
(10) Pub. No.: US 2008/0123704 A1
(43) Pub. Date: May 29, 2008

(54) System and method for regulating the power of a laser beam

(75) Inventors: Peter Von Jan, Seefeld/Hechendorf (DE); Erwin Wagner, Germering (DE); Alistair Baillie Gill, Thaining (DE)

Correspondence Address: DUANE MORRIS LLP, 505 9th Street, Suite 1000, WASHINGTON, DC, 20004-2166, US

(73) Assignee: Raylase AG, Wessling (DE)

(21) Appl. No.: 11/984,495

(22) Filed: Nov. 19, 2007

(30) Foreign Application Priority Data
Nov. 24, 2006 (DE) DE102006055595.3

(51) Int. Cl. H01S 3/13

(52) U.S. Cl. 372/29.021

(57) ABSTRACT

Disclosed is a system (10) for regulating the power of a laser beam (12). The system (10) comprises a first transparent plate (16) that is arranged in the light path of the laser beam (12) and can rotate about a first axis (18), that is perpendicular to the light path, a first drive device (20) for rotating the first transparent plate (16) about the first axis (18), a measurement device (34) for detecting the power of the laser beam (12′) downstream of the first transparent plate (16) and for generating an actual power value, and a regulating device (44) with an input (46a) that is connected to the measurement device (34), and an output (46b) that is connected to the first drive device (20), the regulating device (44) receiving the actual power value and a desired power value and generating a control value which it outputs, wherein the first drive device (20) rotates the first transparent plate (16) depending on the control value, in order to minimize the difference between the actual power value and the desired power value.

### FIELD OF THE INVENTION

The present invention relates to a system and a method for regulating the power of a laser beam. The invention particularly relates to a system and method of regulating the power of a laser beam in a laser scanning system having a laser source and a deflection device having at least one deflection mirror that can be rotated by a galvanometric motor.

### BACKGROUND OF THE INVENTION

Laser beams are used in a wide range of applications for machining work-pieces, for example for cutting, labeling or inscribing them. In some of these applications the power of the laser beam must be regulated. For example, one of the greatest difficulties in the use of CO₂-lasers, which are widely used in the machining of work-pieces, is the inherent instability of their output power. This instability is caused by many different factors, for example by a change in the coolant water temperatures or the expansion and contraction of the laser cavity. Systems are therefore needed that can regulate the power at a constant value.

In other applications the power is not to be regulated at a constant value but rather according to a pre-defined power profile. This is the case for example when marking with different grey levels. Adaptation of the laser beam intensity can also be necessary in order to obtain uniform lines or cutting widths under varying scan speeds on the work-piece surface, for example when marking or cutting corners or tight curves.

In the prior art methods are disclosed for using optical filters or acousto-optical modulators in order to modulate the laser output power.

In German utility model DE 20 2004 009 U1 by the same applicant, a system is further disclosed for regulating the power of a laser beam, which uses a rotatable Brewster-element that is arranged at the Brewster angle to the light path. In this known method the laser light impinging on the Brewster-element is polarized. The Brewster-element can additionally be rotated around an axis parallel to the direction of the laser beam. When the Brewster-element is rotated into a position in which the polarization vector lies in the plane of incidence, according to Brewster's law all the light is transmitted through the Brewster-element and no light is reflected. When on the other hand the Brewster-element is rotated into a position in which the polarization vector is perpendicular to the plane of incidence, virtually all the incident light is reflected and virtually none is transmitted through the Brewster-element. By rotating the Brewster-element between these two extreme positions, the proportion of the transmitted light and thereby the intensity of the emitted laser beam can be adjusted.

U.S. Pat. No. 6,004,487 discloses a method and apparatus for a disk texturing operation in which laser pulses are successively bombarded against a delimited surface area on the face of rotating disk. A pulsed laser beam from a laser light source is adjusted to an optimum power level for an aimed bump diameter using an attenuation device having two rotatable transmission plates which are arranged to turn about a rotational axis perpendicular to the light path. In the preferred embodiment, one of the transmission plates of the light attenuation means is fixedly retained in a predetermined inclined position and the light attenuation means of the second stage is rotatable continuously or step by step in a fine pitch for fine adjustment of the output laser power and at the same time for preventing fluctuations in the output power by feedback control. The system, however, is not adapted for a rapid control of the laser power, as is for example needed in real time regulation of laser power when marking different ray levels during laser scanning.

WO 03/065102 A1 discloses an attenuator for linear polarized laser pulses by rotating or tilting a plate with respect to the light path. A second plate may be arranged in a symmetrical manner to compensate for offset of the pulse from the optical axis. This system is similar to the German utility model DE 20 2004 009 U1.

U.S. Pat. No. 4,747,673 discloses an attenuator for high power laser beams in which the beam passes successively through a pair of pivoting transmissive and reflective elements. The elements are individually mounted on intermeshed gears so that the elements are adjustable through equal and opposite angles. The elements are preferably elements commonly used as edge filters, that is, interference filters having an abrupt monotonic transition with wavelength from reflection to transmission. Both of the intermeshed gears carrying the transmissive and reflective elements are driven by a single motor. The momentum of inertia of the assembly is therefore too high to be useful in laser scanning systems where the laser power is to be controlled in real time, for example for marking at different gray levels.

This known system has proven itself extremely well in practice. It would nevertheless be advantageous to reduce the manufacturing costs of this system and increase the speed with which the power can be regulated. A problem addressed by the present invention therefore is to disclose a system of the type described above, that is cheaper to manufacture, and to disclose a system and a method that enable faster regulation.

### SUMMARY OF THE INVENTION

The system of the invention comprises a first light-transparent plate that is arranged in a section of the light path of the laser beam and can be rotated about a first axis that is perpendicular to the said section of the light path. The system comprises a first drive device for rotating the first transparent plate about the first axis and a measurement device for detecting the power of the laser beam downstream of the first transparent plate and for generating an actual power value. The system further comprises a regulating device with an input that is connected to the measurement device, and an output that is connected to the first drive device, the regulating device receiving the actual power value and a desired power value and generating a control value which it outputs. The first drive device rotates the first transparent plate depending on the control value, in order to minimize the difference between the actual power value and the desired power value.

Whereas therefore in the above cited prior art the Brewster-element (which is also a transparent plate) is always positioned at the Brewster angle to the laser beam and only the plane of incidence is adjusted relative to the polarization direction of the laser light, in the system of the invention, by rotating the transparent plate about the first axis, the angle of incidence of the laser light onto said transparent plate is changed. According to Fresnel's laws, the proportion of the light reflected by the transparent plate and of the light transmitted thereby changes, so that by rotating the transparent plate the intensity of the transmitted laser light can be adjusted.

It has been found that this way of rotating the transparent plate is simpler and cheaper to implement than the rotation of a transparent plate at the Brewster angle about an axis parallel to the laser beam, as is done in the above cited prior art. In the prior art mentioned, each Brewster-element is held in a ball-bearing and is mounted on an inner ring of the ball-bearing. The Brewster-elements have a lever connected to them, which is rotated on the spindle of a motor. In comparison to this prior art the inventive system requires fewer parts and is therefore cheaper. Moreover, the combination of the transparent plate and the associated drive device in embodiments of the invention tends to have a lower moment of inertia than can be achieved with the rotatable Brewster-elements from the prior art, so that the response time of the system is lower than in the prior art.

A further important advantage of the system according to the invention is that the system is very flexible and in particular can be adapted with very little expense to different beam diameters. In the system of the invention essentially only the size of the transparent plate needs to be adapted to the beam diameter. The conventional Brewster-elements from the prior art are by contrast designed for specific beam diameters, to which the size of the ball-bearing used are matched, so that these are only just as large as required for the intended application. This means however that a system designed for a specific beam diameter can not, or at least not optimally, used for other diameters.

The system preferably also includes a second transparent plate, which is arranged in the light path of the laser beam between the first transparent plate and the measurement device and can be rotated about a second axis that is perpendicular to the light path, and a second drive system for rotating the second transparent plate about the second axis. The first and the second drive systems are thereby preferably controlled by the regulating device in such a way that the first and the second transparent plates turn synchronously in opposite directions by the same angular amount.

By the use of two rotatable transparent plates the intended effects are multiplied, that is a certain increase or reduction in the transmission can be achieved by two smaller movements of the two transparent plates, instead of by a larger one, which causes the response time of the system to increase. Controlling both of the drive devices synchronously in opposite directions allows any offset generated due to light refraction on passing through the first transparent plate to be compensated by an offset in the opposite direction when passing through the second transparent element, as will be explained below in more detail with reference to an exemplary embodiment. This is important so that the laser beam is not displaced during the intensity regulation.

The angular region, within which the first and possibly the second transparent plate are turned, preferably includes the Brewster angle with respect to the light path. When the transparent plates form the Brewster angle, all the light polarized parallel to the plane of incidence is transmitted. This position thus represents the maximal transmissivity of the system. On adjusting the transparent plates away from the Brewster angle, the reflection of the incident light increases and the transmission drops. The laser beam which is incident on the first transparent plate is preferably linearly polarized. Additionally the first and possibly the second axis are perpendicular to the polarization plane of the incident laser beam. In this setup a transmission of almost 100% is produced when the two transparent plates are at the Brewster angle to the incident laser beam.

In an advantageous embodiment the first and/or second drive device is a galvanometric motor which is also referred to as “galvanometric scanner” or “galvo” in short. In this case the combination of transparent plate and galvanometric motor is very similar to a deflection element in a X-Y deflection unit. This constructional similarity is extremely advantageous because the components are well matched to one another. If for example the intensity of the laser beam during X-Y scanning is to be varied depending on the location of incidence of the laser beam on a target area, it is advantageous if the system for adjusting the intensity has a dynamic behavior similar to that of the deflection device, and is for instance not slower than the latter.

The system preferably comprises an energy absorber which is so arranged and designed that it can receive the portion of the light reflected from the first and/or second transparent plate and can absorb at least a part of the light energy. It should be noted that the reflected light which is removed from the working beam is reflected in different directions depending on the current position of the first and second transparent element. The energy absorber must therefore be dimensioned so that it can pick up reflected light in every single one of these positions. The energy absorber is preferably a liquid-cooled metal element.

In an advantageous embodiment the measurement device comprises a beam splitter, preferably a half-mirror, which diverts a defined part of the laser beam as a measurement beam on to a power measurement device. Between the beam splitter and the power measurement device a Brewster-element is preferably arranged, which is at the Brewster angle relative to the measurement beam. With this Brewster-element the intensity of the measurement beam can be further reduced, which allows a light sensor to be used that has a high temporal resolution but typically only withstands low beam intensities. In an advantageous extension the Brewster-element can be rotated about an axis parallel to the measurement beam, so that the intensity of the part of the measurement beam incident on the light sensor can be adjusted.

The regulation device preferably comprises a PID-regulator. The transparent plates preferably consist of ZnSe and are coated with an anti-reflection layer.

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur now or in the future to one skilled in the art to which the invention relates.

### SHORT DESCRIPTION OF DRAWINGS

The figures show an exemplary embodiment of the invention, namely:

FIG. 1 is a plan view of essential components of a system for regulating the power of a laser beam,

FIG. 2 is a side view of two transparent plates, as are used in the system of FIG. 1,

FIG. 3 is a block diagram of a laser scanning system comprising a CO₂-laser source for generating a laser beam, a system for regulating the power of the laser beam and a deflection device,

FIG. 4 is a schematic perspective view of the deflection device of FIG. 3.

### DETAILED DESCRIPTION

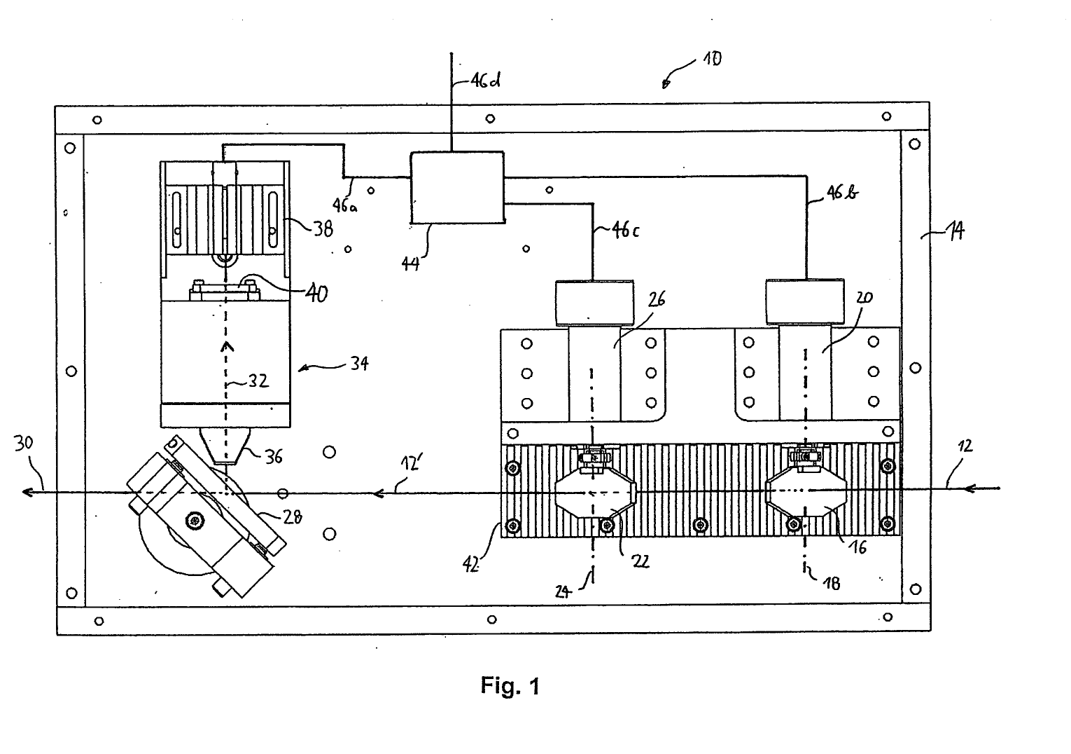

In FIG. 1 a system 10 for regulating the power of a laser beam 12 is shown, which laser beam 12 runs from right to left in the illustration of FIG. 1. The system 10 comprises a housing, only one base plate 14 of which is shown in the illustration of FIG. 1. The system 10 comprises a first transparent plate 16, which is mounted rotatably about a first axis 18 and can be rotated about the first axis 18 by a first drive device 20. In the embodiment shown the first drive device 20 is formed by a galvanometric motor, which in the prior art is also termed a “Galvo-scanner” or a “Galvanometer scanner”.

Behind the first transparent plate 16 with respect to the propagation direction of the laser beam 12, a second transparent plate 22 is disposed, that can rotate about a second axis 24 and can be driven by a second galvanometric motor 26 for rotation about the second axis 24. The laser beam 12 emerging from the second transparent plate 22 is a damped laser beam 12′, the degree of damping depending on the transmission of the transparent plates 16, 22 in their current position.

Following the course of the laser beam 12′, there is next disposed a half-mirror 28, which allows the majority of the laser beam 12′ (e.g. 99%) to pass through as a working beam and diverts a small but defined proportion of the laser beam 12′ as a measurement beam on to a power measuring device 34.

The power measuring device 34 comprises a Brewster-element 36, which is always positioned at the Brewster angle to the measurement beam 32 but can be rotated about an axis parallel to the measurement beam 32. The power measurement device 34 additionally comprises a light sensor (not shown), which is hidden by a cooling element 38 in FIG. 1, and a lens arrangement 40 which focuses the measurement beam 32 onto the light sensor.

The system 10 further comprises an energy absorber 42, which consists of metal and is cooled by a coolant liquid. The absorber 42 shown is located underneath the transparent plates 16 and 22. A similar absorber is also arranged above the transparent plates 16, 22, omitted from FIG. 1 however, to allow a clear view of the transparent plates 16, 22.

Finally the system 10 comprises a regulation unit 44, which is connected via a signal lead 46a to the power measurement device 34 and via signal leads 46b, 46c to the first and second galvanometric motor 20 and 26, respectively. Finally the regulation unit 44 is connected to a signal lead 46d by which it is connected to an external device (not shown), for example a computer.

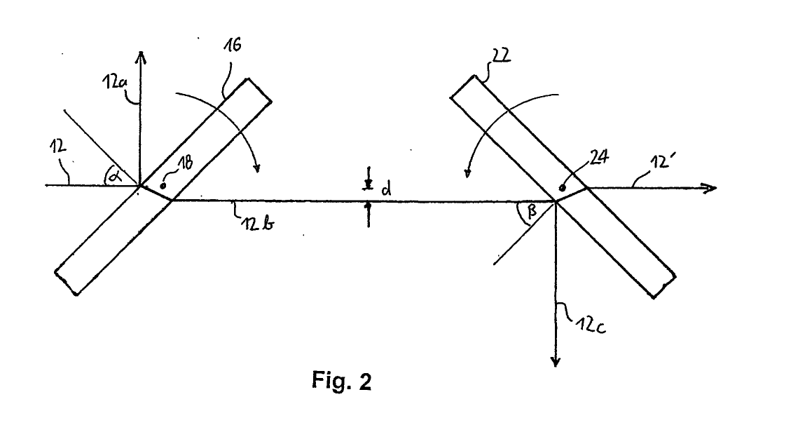

In the following the functioning of the system 10 will be described with reference to FIGS. 1 and 2. In the illustration of FIG. 1 the laser beam 12 enters the system 10 at its right-hand end. In the exemplary embodiment shown, the laser beam 12 is linearly polarized in a plane perpendicular to the paper plane. This linear polarization can either be inherent in the laser source (e.g. a CO₂-laser source), or achieved by polarizer (not shown) connected upstream. The laser beam 12 first impinges at an angle α on the first transparent plate 16, which consists of ZnSe and is coated with an anti-reflective layer. A part 12a of the incident laser beam 12 is reflected by the first transparent plate 16 (see FIG. 2) and is deflected on to the energy absorber 42, which absorbs the light energy. The reflected part of the lights corresponds to the part of the power which is to be removed from the laser beam 12 in the process of power regulation. A part 12b of the laser beam 12 is transmitted through the transparent plate 16. this transmitted part 12b is refracted upon entering into and passing out of the transparent plate 16, so that the propagation direction of the transmitted beam 12b is the same as that of the incident laser beam 12, but the transmitted laser beam 12b is shifted by an offset d (see FIG. 2).

The transmitted beam 12b then impinges on the second transparent plate 22, the absolute value of the angle of incidence β of the beam 12b is equal to that of the angle of incidence α, but the angles α and β lie on different sides of a respective vertical line at the first and second transparent plates 16, 22 and therefore have different signs (α=−β). A part of the beam 12b incident on the second transparent plate 22 is reflected by the latter as beam 12c and absorbed by the energy absorber 42. The other part of the light beam 12b is transmitted by the second transparent plate 22 as damped beam 12′. Upon entry and exit of the beam 12b into and out of the transparent plate 22, the beam 12′ is refracted in turn, and because of the symmetric arrangement of the transparent plates 16, 22 (i.e. α=−β), the offset d is compensated by this refraction. It should be noted that the offset d is dependent on the angle α and in an asymmetric arrangement would therefore be difficult to compensate for.

The ratio between transmitted and reflected light, i.e. the ratio of the intensities of the beams 12b to 12 and 12′ to 12b depends on the respective angle of the transparent plate 16, 22, the galvanometric motors 20, 26 are constantly controlled via the signal leads 46b, 46c in such a way that the first and second transparent plate 16, 22 rotate synchronously in opposite directions, so that α=−β holds at all times. By adjusting the angles α and β the intensity of the laser beam 12′ that has passed through both, the first and second plates 16, 22 can thus be adjusted. In particular, if α and β are equal to the Brewster angle, no light is reflected (i.e. the intensity of the reflected light beams 12a, 12c is zero) and the intensity of the emerging light beam 12′ is equal to the intensity 12 of the incident laser beam. In other words, the arrangement formed by the transparent plates 16, 22 is adjusted to maximum transmission, when the angles α and β are equal to the Brewster angle.

If the transparent plates 16, 22 are turned away from the Brewster angle, however, the reflected portion increases and the transmitted portion decreases, which allows the power of the emerging laser beam 12′ to be made arbitrarily small. It should be noted that the effects of the first and second transparent plates 16, 22 are multiplied together. This means that in order to achieve a specific change in the damping of the transmitted laser beam 12′, smaller movement of the individual transparent plates 16, 22 is necessary than if the same change in the damping were to be achieved by adjusting only one transparent plate. This allows in turn a shorter response time of the system 10 and a more rapid regulation of the power.

As can furthermore be seen in FIG. 1, the laser beam 12′ transmitted by the transparent plates 16, 22 is split up at the beam splitter 28 into a working beam 30 and a measurement beam 32. The intensity of the measurement beam 32 is a small, but firmly defined fraction of the intensity of the beam 12′, for example 1%. Even this relatively small proportion of the laser beam 12′ however, when using high-power lasers such as a CO₂-laser, often still has too great an intensity for a light sensor to withstand. For the light sensor (not shown), for example a CMOS-element could be used, which is characterized by a very fast response time, which although advantageous with regard to a fast regulation time nevertheless would be damaged by excessive light energies. In order to damp the measurement beam 32 further, it is passed through a Brewster element 36, which can be rotated about a measurement axis parallel to the measurement beam 32. By rotation of the Brewster element 36, an adjustable part of the measurement beam 32 is transmitted and the remainder of the measurement beam 32 is reflected and absorbed. In this way a damped measurement beam 32 can be obtained, having an intensity that is far less than 1% of the intensity of the laser beam 12′.

The damped measurement beam 32 is focused by a lens assembly 40 onto the light sensor (not shown). At first glance, the focusing may appear at first glance to contradict the objective given above, namely to limit the intensity of the measurement beam 32 on the light sensor (not shown). In fact, however, experiments by the inventor have shown however that such a focusing is advantageous, as it can ensure that the total energy of the measurement beam 32 is also actually detected by the light sensor (not shown). If the measurement beam 32 were not focused, it may happen in practice that, due to an offset of the measurement beam 32, a part of the cross-section of the measurement beam 32 lies outside of the light sensor and is not taken into account during regulation. By using the Brewster-element 36 together with the half-mirror 28, the measurement beam 32 can be damped to such an extent that its intensity on the light sensor, in spite of the focusing, is not damaging to it.

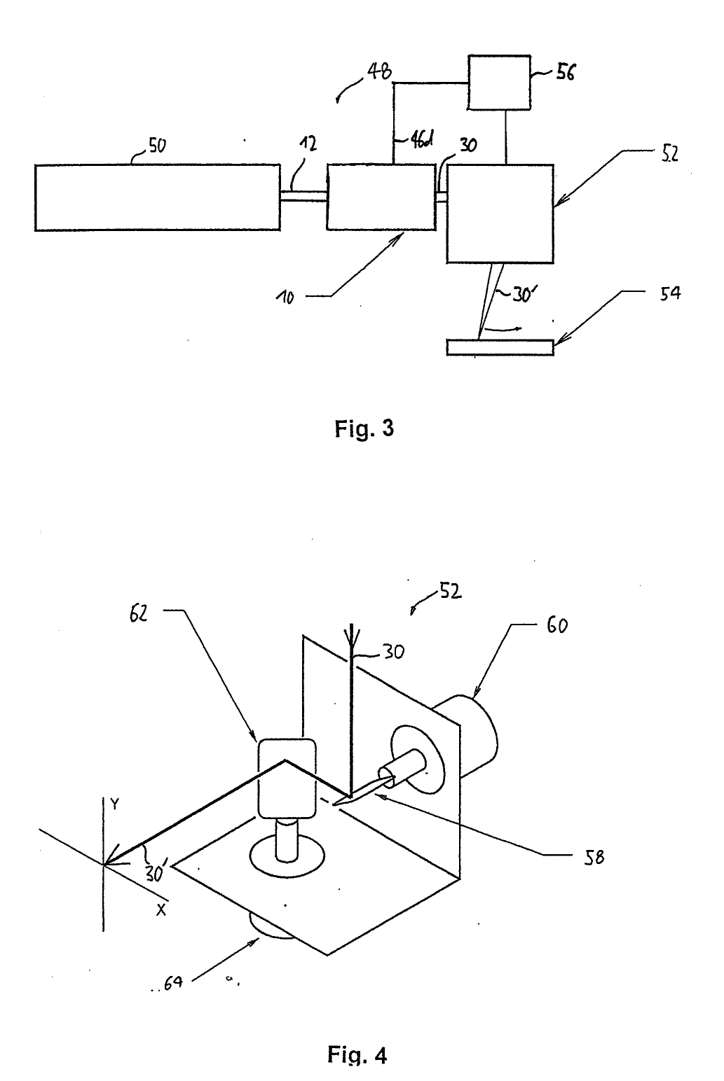

The intensity of the measurement beam 32 is input via the signal lead 46a into the regulation unit 44 as an actual value of the laser beam intensity. Via the signal lead 46d a desired or set value of the laser power is input into the regulation unit 44. The desired value could be for example a temporally constant desired output power of the working beam 30, which is thereby stabilized in time by means of the regulation unit 10. The desired value input could also be a time-dependent power profile, as will be described in further detail with reference to FIGS. 3 and 4.

The regulation unit 44 compares the actual power value from the power measurement device 34 with the desired power value, and a PID-regulator determines from this comparison a control signal or position signal which is fed to the first and second galvanometric motor 29, 36 via signal leads 46b or 46c. The position signals are of a type such that the two transparent plates 16, 22 are constantly rotated synchronously in opposite directions, so that the relation α=−β (see FIG. 2) is always maintained.

FIG. 3 shows a laser scanning system 48 comprising a laser source 50, which in the exemplary embodiment shown is formed by a CO₂-laser and emits a laser beam 12, and the regulation system 10 of FIG. 1, which receives the laser beam 12 and guides a working beam 30, the power of which being regulated to a desired value, into a deflection device 52. The deflection device 52 deflects the working beam 30 into a deflected beam 30′, and scans a surface of the work-piece 54 therewith. The system 10 and the deflection device 52 are connected to a computer 56.

In FIG. 4 essential elements of the deflection unit 52 are shown. The deflection unit 52 comprises a Y-deflection mirror 58, which is driven by a galvanometric motor 60, and a X-deflection mirror 62, which is driven by a galvanometric motor 64. The galvanometric motors 60, 64 of the deflection system 52 are controlled by the computer 56, in order to scan the surface of the work-piece 54 with the deflected laser beam 30′. When scanning the work-piece 54 the intensity of the working beam 30 is regulated. For example the intensity of the working beam 30′ can be increased to counteract a defocusing of the deflected working beam 30′, which occurs if the point of incidence on the target surface of the work-piece 54 is a long distance away from the centre of the surface. This kind of defocusing is known by the term “field-flattening”. By increasing the intensity of the working beam 30′ at points where the focusing is less sharp, this defocusing can be counteracted. Also, the power of the working laser beam 30 can be adapted to the scan velocity. At a high scan velocity, the power is increased, while at a low scan velocity, for example during changes of direction when marking or cutting corners, it is reduced. In the exemplary embodiment shown, this is achieved by having the computer 56 feed a suitable desired-value profile into the system via the signal lead 46d during the scanning.

As can be seen from FIG. 4, the driving means of the X- and Y-mirrors 62, 58 is similar to the driving means of the first and second transparent plates 16, 22. In the ideal case, even identical galvanometric motors can be used. From this structural similarity, not only can costs be saved, but the response times of the deflection system 52 and the regulation system 10 and very similar, so that these components are optimally matched to each other and a speed of regulating the laser light intensity is achieved as seems to be barely achievable with conventional Brewster-elements.

The features shown in the present description, claims and drawings can be relevant both separately and in arbitrary combination for the implementation of the invention in the various embodiments.

### LIST OF REFERENCE MARKS

10 System for regulating the power of a laser beam
12, 12′ Laser beam
14 Base plate
16 first transparent plate
18 first axis
20 first galvanometric motor
22 second transparent plate
24 second axis
26 second galvanometric motor
28 half-mirror
30 working laser beam
32 measurement laser beam
34 power measuring device
36 Brewster-element
38 cooling element
40 lens assembly
42 energy absorber
44 regulation unit
46s-46d signal leads
48 laser scanning system
50 CO₂-laser
52 deflection device
54 work-piece
56 computer
58 Y-mirror
60 galvanometric motor
62 X-mirror
64 galvanometric motor

1. A system (10) for regulating the power of a laser beam (12), comprising:
a first transparent plate (16), which is arranged in a section of the light path of the laser beam (12) and can be rotated about a first axis (18) perpendicular to said section of the light path,
a first drive device (20) for rotating the first transparent plate (16) about the first axis (18),
a measurement device for detecting the power of the laser beam (12′) downstream of the first transparent plate (16) and for generating an actual power-value,
a regulation device (44) having an input (46a), which is connected to the measurement device, and an output (46b) that is connected to the first drive device (20),
wherein the regulation device (44) obtains the actual power value and a desired power value and generates and outputs a control value,
wherein the first drive device (20) rotates the first transparent plate (16) according to the control value, in order to minimize the difference between the actual power value and the desired power value.

2. The system (10) according to claim 1, which additionally comprises the following:
a second transparent plate (22), which is disposed in the light path of the laser beam between the first transparent plate (16) and the measurement device and can be rotated about a second axis (24), which is perpendicular to the light path, and
a second drive device (26) for rotating the second transparent plate (22) about the second axis (24).

3. The system (10) according to claim 2, in which the first and the second drive devices (20, 26) are controlled by the regulation unit (44) in such a way that the first and the second transparent plates (16, 22) rotate synchronously in opposite directions by the same angular amount.

4. The system (10) according to claim 3, in which the first and the second axis (18, 24) are parallel to each other and the angle (α) between the first transparent plate (16) and the light path and the angle (β) between the second transparent plate (22) and the light path have the same absolute value and opposite signs.

5. The system (10) according to claim 1, in which the angular region, within which the first transparent plate (16, 22) can be rotated, includes the Brewster angle with respect to the light path.

6. The system (10) according to claim 1, in which the laser beam (12), which is incident on the first transparent plate (16), is polarized.

7. The system (10) according to claim 6, in which the first axis (18) and if present the second axis (24) is or are perpendicular to the polarization plane of the laser beam (12).

8. The system (10) of claim 1, in which the first drive device comprises a galvanometric motor (20).

9. The system (10) of claim 2, in which the second drive device comprises a galvanometric motor (26).

10. The system (10) according to claim 1, said system having an energy absorber (42), which is so arranged and designed that it can receive the portion of the light (12a, 12c) reflected from the first and/or second transparent plate (16, 22) and can absorb at least a part of the light energy.

11. The system (10) according to claim 10, in which the energy absorber (42) is a fluid-cooled metal element.

12. The system (10) according to claim 1, said system having a beam-splitter, preferably a half-mirror (28), which diverts a defined part of the laser beam (12′) as a measurement beam (36) onto a power measurement device (34).

13. The system (10) according to claim 12, wherein between the beam-splitter (28) and the power measurement device (34) a Brewster-element (36) is disposed, which is at the Brewster angle relative to the measurement beam (32).

14. The system (10) according to claim 13, in which the Brewster-element (36) can be rotated about an axis parallel to the measurement beam (32).

15. The system (10) according to claim 12, in which the power measurement device (34) comprises a light sensor and a focusing device (40), which focuses the measurement beam (32) onto the light sensor.

16. The system (10) according to claim 1, in which the regulation unit (44) comprises a PID-regulator.

17. The system (10) according to claim 1, said system having an input device (56) for inputting a constant desired power value or a desired power value profile into the regulation unit (44).

18. The system (10) according to claim 1, in which the first transparent plate (16, 22) is made of ZnSe and is coated with an anti-reflective layer.

19. A laser scanning system (48) with a laser source (50), in particular a CO₂-laser source, for generating a laser beam (12), comprising:
a system (10) for regulating the power of the laser beam (12) comprising:
a first transparent plate (16), which is arranged in a section of the light path of the laser beam (12) and can be rotated about a first axis (18) perpendicular to said section of the light path,
a first drive device (20) for rotating the first transparent plate (16) about the first axis (18),
a measurement device for detecting the power of the laser beam (12′) downstream of the first transparent plate (16) and for generating an actual power-value, and
a regulation device (44) having an input (46a), which is connected to the measurement device, and an output (46b) that is connected to the first drive device (20), wherein the regulation device (44) obtains the actual power value and a desired power value and generates and outputs a control value,
wherein the first drive device (20) rotates the first transparent plate (16) according to the control value, in order to minimize the difference between the actual power value and the desired power value, and
a deflection device (52) having at least one deflection mirror (58, 62), which can be rotated by a galvanometric motor (60, 64).

20. The laser scanning system (48) of claim 19, wherein said first drive device comprises a galvanometric motor.

21. A method for regulating the power of a laser beam (12), comprising the steps of:
feeding the laser beam (12) through a first transparent plate (16), which can be rotated about a first axis (18) perpendicular to the light path of the laser beam (12),
determining the power of the laser beam (12′) downstream of the first transparent plate (16) by a measuring device
generating an actual power value,
providing the actual power value to a regulation device (44),
comparing the actual power value with a desired power value,
generating a control value as a function of the comparison, and
rotating the first transparent plate (16) as a function of the control value, to minimize the difference between the actual power value and the desired power value.
